(19) United States
(12) Patent Application Publication
(10) Pub. No.: US 2019/0241145 A1
(43) Pub. Date: Aug. 8, 2019

(54) REAR-SEAT AIRBAG DEVICE

(71) Applicant: MAZDA MOTOR CORPORATION, Hiroshima (JP)

(72) Inventors: Teruhiko HIRUTA, Hiroshima-shi (JP); Mie YOSHIMURA, Hiroshima-shi (JP); Taei SHIBAHARA, Hiroshima-shi (JP); Takahiro NARIKAWA, Kawaguchi-shi (JP)

(73) Assignee: MAZDA MOTOR CORPORATION, Hiroshima (JP)

(21) Appl. No.: 16/178,161

(22) Filed: Nov. 1, 2018

(30) Foreign Application Priority Data
Feb. 6, 2018 (JP) 2018-019537

(51) Int. Cl. B60R 21/231; B60R 21/207

(52) U.S. Cl. CPC B60R 21/231; B60R 2021/0044; B60R 2021/23153; B60R 21/207

(57) ABSTRACT

An airbag of a rear-seat airbag device includes an deployment part which is deployed from a seatback of a front seat toward the vehicle rearward side and then toward a vehicle downward-and-forward side up to the seatback when the airbag is inflated and deployed, and the deployment part includes a stretch portion which is stretchable according to a tension acting on a tip portion of the deployment part when the airbag is inflated and deployed.

### BACKGROUND OF THE INVENTION

The present invention relates to a rear-seat airbag device which comprises an airbag provided in a seatback of a front seat and configured to be inflated and deployed toward a vehicle rearward side in a vehicle collision.

In general, a vehicle, such as an automotive vehicle, is equipped with a collision detecting device to detect a vehicle frontal collision, such as an acceleration sensor, which is provided at a vehicle-body front portion, wherein an airbag device is operated when the vehicle frontal collision is detected by the collision detecting device, thereby protecting an occupant in a cabin.

In a vehicle equipped with a front seat and a rear seat, it is known that a rear-seat airbag device which protects an occupant seated in the rear seat is installed in addition to a front-seat airbag device which protects an occupant seated in a driver's seat or an assistant driver's seat as the front seat.

Japanese Patent Laid-Open Publication No. H05-16759, for example, discloses a rear-seat airbag device in which an inflator and a folded airbag are arranged at a headrest or a back face of a seatback of a front seat, wherein the airbag is inflated and deployed toward a vehicle rearward side by changing an inflation-gas pressure distribution of the inflator in accordance with a state of the front seat in a vehicle collision, thereby protecting an occupant seated in a rear seat.

Herein, in the rear-seat airbag device comprising the airbag folded in the seatback of the front seat, it is requested that the occupant seated in the rear seat is securely protected in the vehicle collision regardless of the body size of the occupant because not only a standard-sized occupant but a large-sized occupant or a small-sized occupant are seated.

### SUMMARY OF THE INVENTION

Accordingly, an object of the present invention is to provide a rear-seat airbag device comprising an airbag to protect an occupant seated in a rear seat which can securely protect the occupant regardless of the body size of the occupant.

The present invention is a rear-seat airbag device which is installed to a vehicle equipped with a front seat and a rear seat, comprising an airbag provided in a seatback of the front seat and configured to be inflated and deployed toward a vehicle rearward side for protecting an occupant seated in the rear seat in a vehicle collision, wherein the airbag includes an deployment part which is deployed from the seatback toward the vehicle rearward side and then toward a vehicle downward-and-forward side up to the seatback of the front seat when the airbag is inflated and deployed, and the deployment part of the airbag includes a stretch portion which is stretchable according to a tension acting on a tip portion of the deployment part when the airbag is inflated and deployed.

According to the present invention, the airbag can securely protect the chest and the knee of the occupant which is respectively achieved by its part deployed toward the vehicle rearward side and its part deployed toward the vehicle downward-and-forward side from the above-described rearwardly-deployed part of the airbag.

Since the deployment part of the airbag includes the stretch portion which is stretchable according to the tension acting on the tip portion of the deployment part when the airbag is inflated and deployed, the airbag can be made close to the chest of the occupant by stretching the stretch portion in accordance with the body size of the occupant, so that the occupant can be securely protected even in a case where the body size of the occupant differs.

In an embodiment of the present invention, the airbag includes, as the deployment part, a curved deployment part which is deployed in a curved shape from the seatback toward the vehicle rearward side for protecting a chest of the occupant and a linear deployment part which is deployed in a linear shape from the curved deployment part toward the vehicle downward-and-forward side up to the seatback of the front seat for protecting a knee of the occupant, and the linear deployment part has the stretch portion at a vehicle forward side thereof.

According to this embodiment, a hollow is formed between the curved deployment part and the linear deployment part, so that the airbag can be made properly compact. Further, the airbag is deployed promptly in the vehicle collision, so that the protection of the chest and the knee of the occupant can be effectively achieved by the curved deployment part and the linear deployment part. Even in a case where a distance between the front seat and the rear seat changes, the airbag deployment is made so fast that the occupant protection can be secured.

In another embodiment of the present invention, the linear deployment part of the airbag is configured to be deployed linearly in an inclined direction from a position located on the vehicle rearward side and on a vehicle upward side of the knee of the occupant to a position located on the vehicle forward side and on a vehicle downward side of the knee of the occupant.

According to this embodiment, since the linear deployment part is deployed linearly in the inclined direction from the position located on the vehicle rearward side and on the vehicle upward side of the knee of the occupant to the position located on the vehicle forward side and on the vehicle downward side of the knee of the occupant, the occupant protection can be effectively achieved by the airbag including the linear deployment part. Further, the linear deployment part moves in the vertical direction and also the curved deployment part moves in the vertical direction in accordance with the body size of the occupant when the airbag is inflated and deployed, the airbag can be properly made close to the knee or the chest of the occupant even in a case where a distance between the front seat and the knee of the occupant or a distance between the front seat and the chest of the occupant changes in accordance with the body size of the occupant.

Other features, aspects, and advantages of the present invention will become apparent from the following description which refers to the accompanying drawings.

### BRIEF DESCRIPTION OF THE DRAWINGS

FIG. 1 is a side view of a vehicle to which a rear-seat airbag device according to an embodiment of the present invention is installed.

FIG. 2 is a perspective view showing a front seat.

FIG. 3 is a perspective view showing a state where an airbag arranged in the front seat is inflated and deployed.

FIG. 4 is a side view showing the state where the airbag arranged in the front seat is inflated and deployed.

FIG. 5 is a back view showing the state where the airbag arranged in the front seat is inflated and deployed.

FIG. 6 is a sectional view of the airbag, taken along line Y6-Y6 of FIG. 4.

FIG. 7 is a sectional view of the airbag, taken along line Y7-Y7 of FIG. 5.

FIG. 8 is a sectional view of the airbag, taken along line Y8-Y8 of FIG. 5.

FIG. 9 is an explanatory diagram explaining the state where the airbag is inflated and deployed.

### DETAILED DESCRIPTION OF THE INVENTION

Hereafter, an embodiment of the present invention will be described referring to the attached drawings.

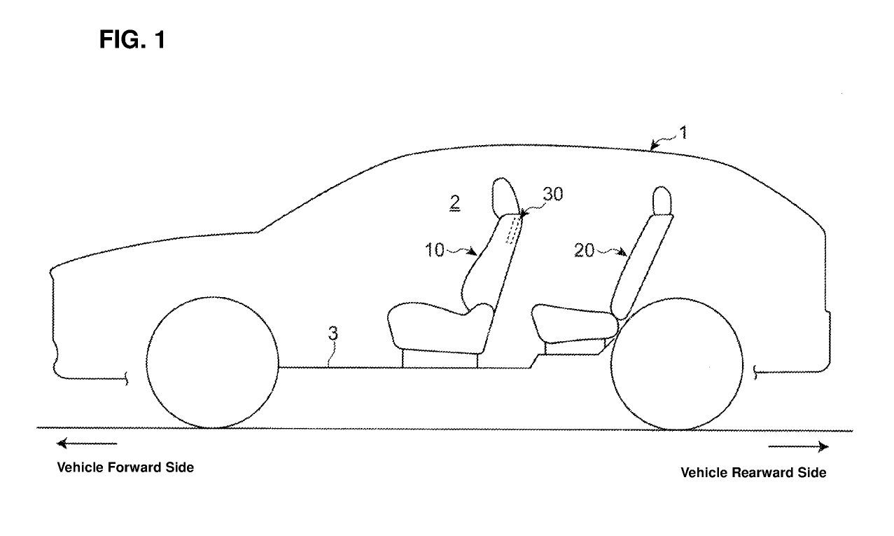

FIG. 1 is a side view of a vehicle to which a rear-seat airbag device according to the embodiment of the present invention is installed. As shown in FIG. 1, a vehicle 1 to which the rear-seat airbag device according to the embodiment of the present invention is installed is equipped, in a cabin 2, with a front seat 10 which is a driver's seat or an assistant driver's seat and a rear seat 20 which is arranged on a vehicle rearward side of the front seat 10. The front seat 10 and the rear seat 20 are respectively attached onto a floor panel 3 so as to be movable in a vehicle longitudinal direction.

In addition to a front-seat airbag device (not illustrated) which protects an occupant seated in the driver's seat or the assistant driver's seat as the front seat, a rear-seat airbag device 30 which protects an occupant seated in the rear seat 20 is installed to the vehicle 1. The rear-seat airbag device 30 is arranged at the front seat which is the driver's seat or the assistant driver's seat.

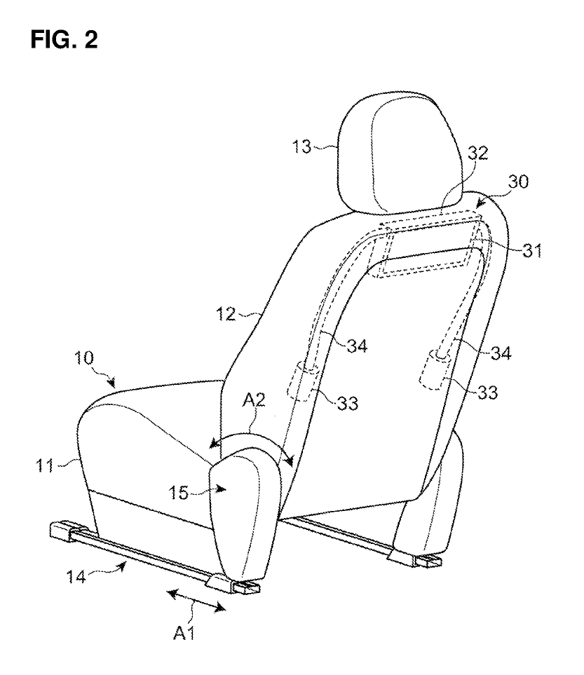

FIG. 2 is a perspective view showing the front seat. As shown in FIG. 2, the front seat 10 which is the driver's seat or the assistant driver's seat comprises a seat cushion 11, a seatback 12 which is connected to a rear end portion of the seat cushion 11, and a headrest 13 which is connected to an upper end portion of the seatback 12.

The front seat 10 is configured to be movable in the vehicle longitudinal direction as shown by an arrow A1 by means of a longitudinal adjusting mechanism 14 to adjust a longitudinal position of the seat cushion 11. The front seat 10 is also configured such that an inclination angle of the seatback 12 is changeable as shown by an arrow A2 by means of an angle adjusting mechanism 15 to adjust the inclination angle of the seatback 12.

The rear-seat airbag device 30, which is arranged in the seatback 12, comprises an airbag 31, a case 32 which is arranged at an upper side of the seatback 12 and holds and stores the folded airbag 31, and inflators 33 (gas generating device) which are arranged at a central side, in a vertical direction, of the seatback 12 and operate to inflate and deploy the airbag 31 by supplying gas into the airbag 31 in a vehicle collision.

The rear-seat airbag device 30 further comprises a reaction plate (not illustrated) to apply a reaction to the airbags 31 when the airbag 31 is inflated and deployed, which is fixed to a seatback frame arranged in the seatback 12 and attached to a vehicle forward side of the case 32.

The inflators 33 are provided at both sides, in a vehicle width direction, of the seatback 12, and attached to the seatback frame arranged in the seatback 12. The inflators 33 are connected to the airbag 31 stored in the case 32 by way of gas supply pipes 34.

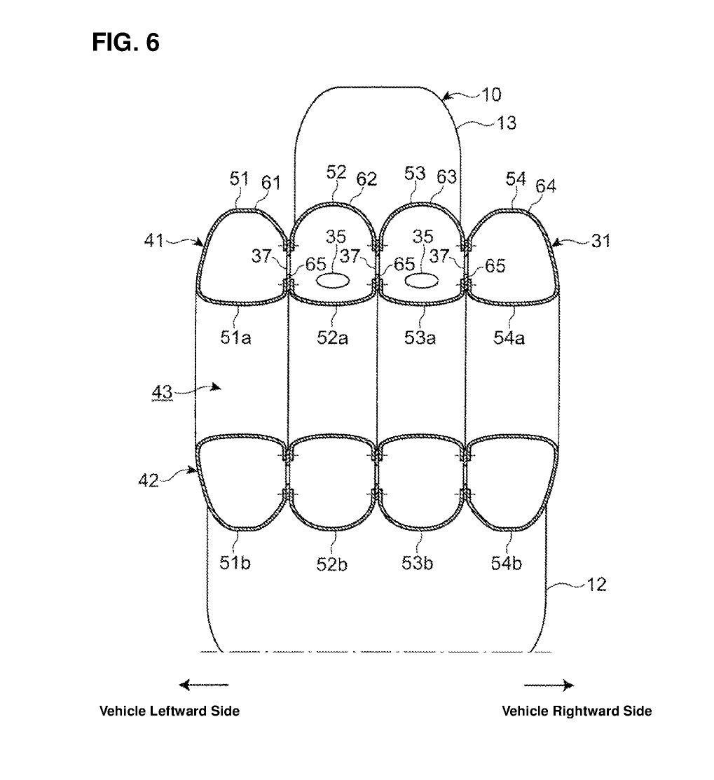

The airbag 31 has gas supply ports 35 through which the gas is supplied from the inflators 33 via the gas supply pipes 34, and as shown in FIG. 6 which will be described later, the two gas support ports 35 are arranged side by side in the vehicle width direction.

The seatback 12 further includes a breakage part (not illustrated) which is broken by the airbag 31 when the airbag 31 is inflated and deployed. This breakage part is configured such that its thickness is thinner than that of the other part at a vehicle rearward side of the seatback 12, so that the breakage part is broken by an inflation pressure of the airbag 31, for example.

The rear-seat airbag device 30 is configured such that the inflators 33 operate in the vehicle collision to supply the gas into the airbag 31, and the breakage part of the seatback 12 is broken when the airbag 31 is inflated and deployed by the gas from the inflators 33 so that the airbag 31 is inflated and deployed toward a vehicle rearward side from the seatback 12, whereby an occupant seated in the rear seat 20 is prevented from hitting against the front seat and thereby the occupant is protected.

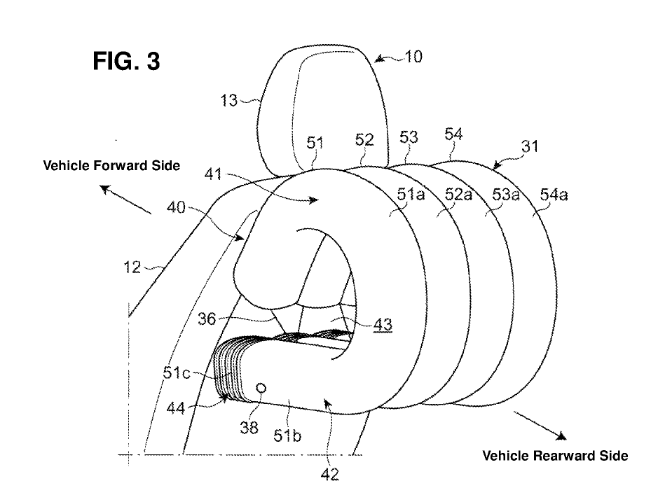

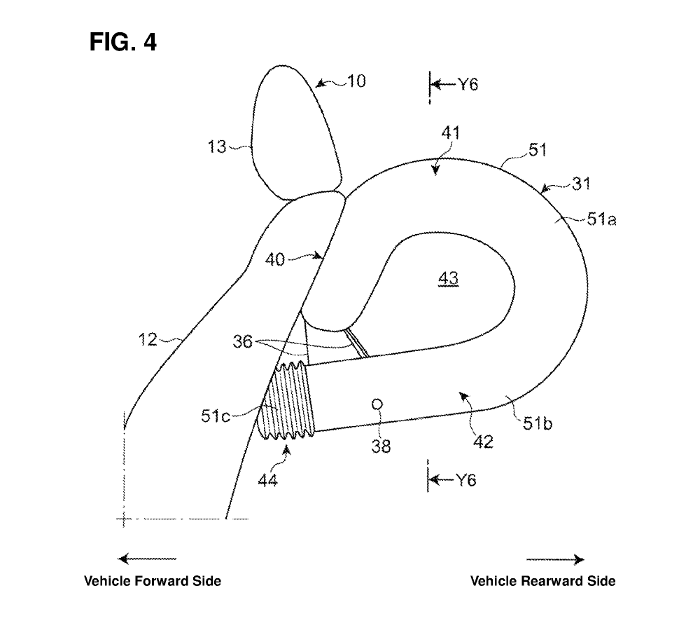

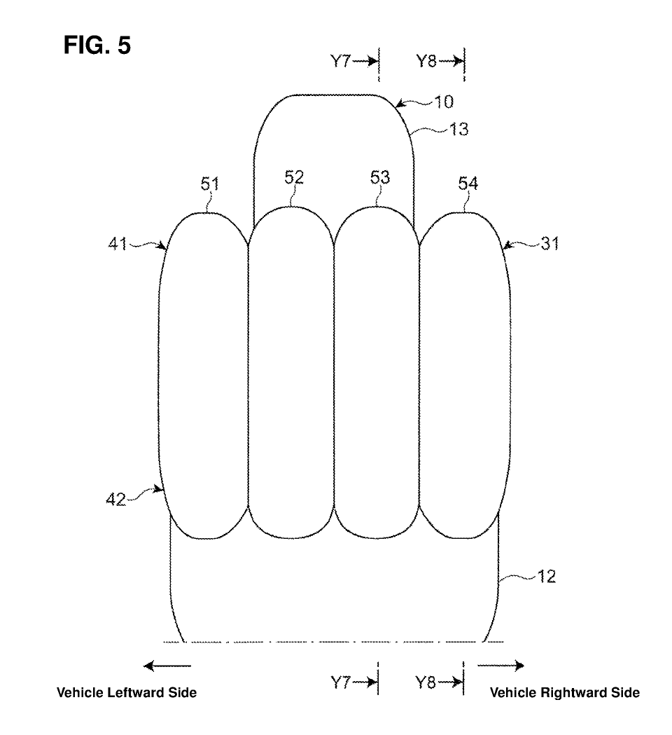

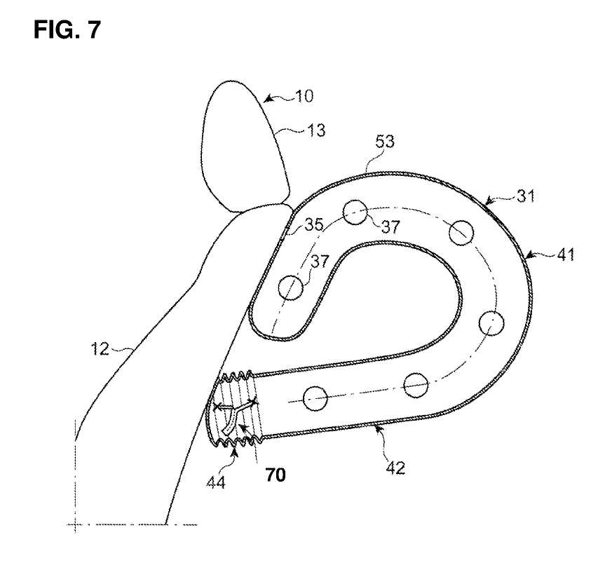

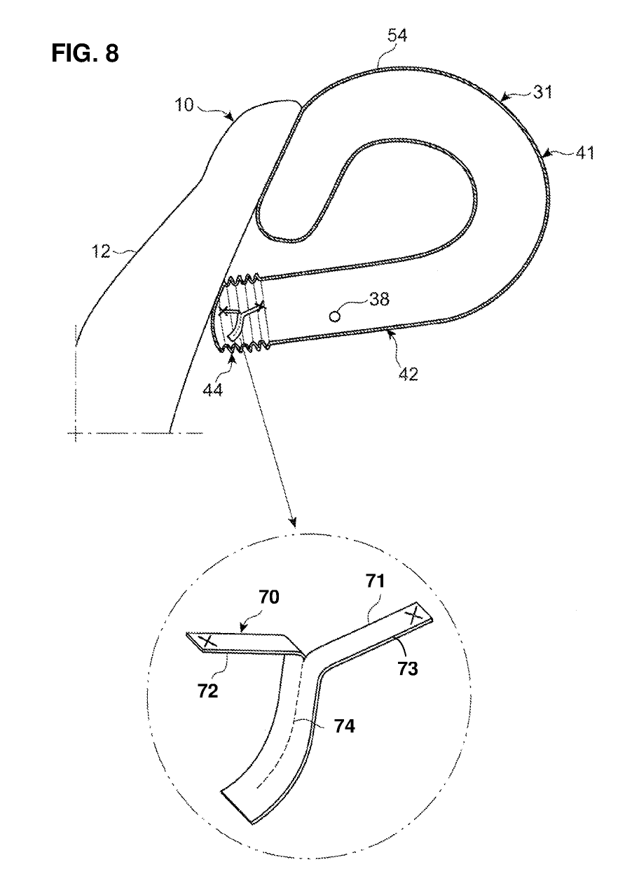

FIGS. 3, 4 and 5 are respectively perspective, side, and back views showing a state where the airbag arranged in the front seat is inflated and deployed. FIG. 6 is a sectional view of the airbag, taken along line Y6-Y6 of FIG. 4, FIG. 7 is a sectional view of the airbag, taken along line Y7-Y7 of FIG. 5, and FIG. 8 is a sectional view of the airbag, taken along line Y8-Y8 of FIG. 5.

As shown in FIGS. 3 through 8, the airbag 31 includes a deployment part 40 which is deployed from an upper portion of the seatback 12 toward the vehicle rearward side and then toward a vehicle downward-and-forward side up to the central portion, in the vertical direction, of the seatback 12 in a side view when the airbag 31 is inflated and deployed. The deployment part 40 comprises a curved deployment part 41 which is deployed in a curved shape from the upper portion of the seatback 12 toward the vehicle rearward side and a linear deployment part 42 which is deployed in a linear shape from the curved deployment part 41 toward the vehicle downward-and-forward side up to the central portion, in the vertical direction, of the seatback 12.

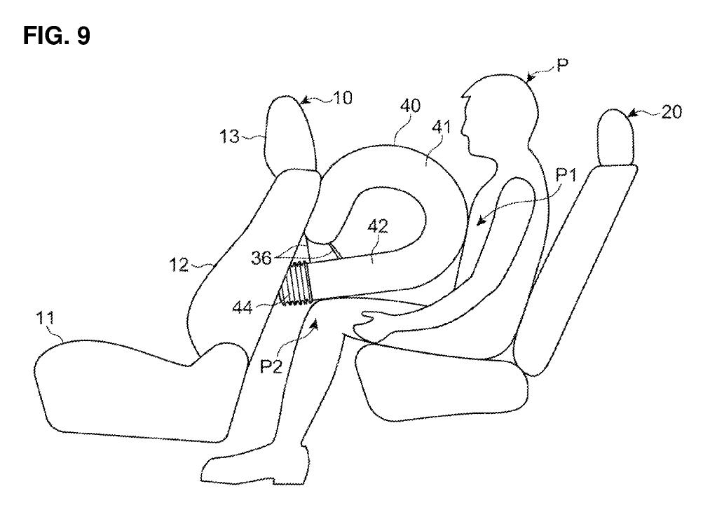

As shown in FIG. 9 which will be described later, the curved deployment part 41 is deployed in an area located in front of a chest P1 of an occupant P seated in the rear seat 20, thereby protecting the chest P1. The linear deployment part 42 is deployed in another area located in front of and above a knee P2 of the occupant P, thereby protecting the knee P2.

The linear deployment part 42 is deployed in the liner shape from the curved deployment part 41 to a position located on the vehicle forward side of the knee P2 of the occupant P so as to cover in front of and above the knee P2 such that the linear deployment part 42 is deployed linearly in an inclined direction from a position located on a vehicle rearward side and on a vehicle upward side of the knee P2 to a position located on a vehicle forward side and on a vehicle downward side of the knee P2.

A vehicle forward side of the curved deployment part 41 and a vehicle forward side of the linear deployment part 42 are interconnected by a connecting tether 36. The linear deployment part 42 is arranged by using the connecting tether 36 such that the vehicle forward side of the linear deployment part 42 is downwardly spaced apart from the vehicle forward side of the curved deployment part 41 and movable in the vertical direction in accordance with a body size of the occupant P seated in rear seat 20.

The connecting tether 36 is configured such that the linear deployment part 42 contacts the knee P2 of the occupant P in its pulled state when a small-sized occupant is seated in the rear seat 20, the linear deployment part 42 contacts the knee P2 of the occupant P in its slightly loosened state when a standard-sized occupant is seated in the rear seat 20, and the linear deployment part 42 contacts the knee P2 of the occupant P in its greatly loosened state when a large-sized occupant is seated in the rear seat 20.

The deployment part 40 of the airbag 31 further includes a stretch portion 44 which is stretchable in the vehicle longitudinal direction according to a tension acting on a tip portion of the deployment part 40 when the airbag 31 is inflated and deployed. This stretch portion 44 is provided at the tip portion of the deployment part 40 which is deployed from the seatback 12 toward the vehicle rearward side and then toward the vehicle downward-and-forward side up to the seatback 12 when the airbag 31 is inflated and deployed.

The airbag 31 specifically comprises a first bag portion 51, a second bag portion 52, a third bag portion 53, and a fourth bag portion 54 which are respectively of a hollow-cylindrical shape, having substantially the same shape, when the airbag 31 is inflated and deployed. These bag portions 51-54 are aligned in the vehicle width direction from a vehicle leftward side to a vehicle rightward side.

These bag portions 51, 52, 53, 54 respectively comprise curved deployment parts 51a, 52a, 53a, 54a which are respectively deployed in the curved shape from the upper portion of the seatback 12 toward the vehicle rearward side, protruding in a roughly semicircular-arc shape, and linear deployment parts 51b, 52b, 53b, 54b which are respectively deployed in the linear shape from the curved deployment parts 51a, 52a, 53a, 54a toward the vehicle downward-and-forward side up to the central portion, in the vertical direction, of the seatback 12.

The curved deployment part 41 of the airbag 31 comprises the curved deployment parts 51a, 52a, 53a, 54a of the first, second, third, and fourth bag portions 51, 52, 53, 54, and the linear deployment part 42 of the airbag 31 comprises the linear deployment parts 51b, 52b, 53b, 54b of the first, second, third, and fourth bag portions 51, 52, 53, 54.

Further, the first, second, third, and fourth bag portions 51, 52, 53, 54 respectively include stretch portions 51c, 52c, 53c, 54c which are respectively stretchable in the vehicle longitudinal direction according to respective tensions acting on respective tip portions of the linear deployment parts 51b, 52b, 53b, 54b when the airbag 31 is inflated and deployed. These stretch portions 51c, 52c, 53c, 54c are respectively provided at the tip portions of the linear deployment parts 51b, 52b, 53b, 54b.

The above-described stretch portions 51c, 52c, 53c, 54c are configured to respectively stretch in a deployment direction by making the tensions act on the tip portions of the linear deployment parts 51b, 52b, 53b, 54b with the inflation pressure of the airbag 31 until the airbag 31 comes to contact the occupant seated in the rear seat 20 when the airbag 31 is inflated and deployed.

As shown in FIG. 8, the stretch portion 54c which is provided at the linear deployment part 54b of the fourth bag portion 54 is folded in a bellows shape so that a fourth sheet 64 which constitutes the fourth bag portion 54 can stretch in an inflation direction of the fourth bag portion 54, and the stretch portion 54c is provided with a stretch tether 70 which is attached to an inside of the fourth sheet 64 which is folded in the bellows shape.

The stretch tether 70 is formed by a rectangular sheet which is made of synthetic resin or the like. The stretch tether 70 comprises a pair of tongue piece parts 72, 73 which are formed by separating one end portion of the stretch tether 70 along a cut 71 which is positioned at a center of a short side of the stretch tether 70. The stretch tether 70 further includes a perforation line 74 which is formed in parallel to a long side of the stretch tether 70 and contiguously to the above-described cut 71.

A one-side tongue piece part 72 of the stretch tether 70 is sewed to one side, in the deployment direction, of the fourth sheet 64 which is folded in the bellows shape, and the other-side tongue piece part 73 of the stretch tether 70 is sewed to the other side, in the deployment direction, of the fourth sheet 64 which is folded in the bellows shape. In FIG. 8, sewed points of the stretch tether 70 to the fourth sheet 64 are indicated by X marks.

The stretch portion 54c of the fourth bag portion 54 is configured such that when the tension is made to act on the tip portion of the linear deployment part 54b by the inflation pressure of the airbag 31 until the airbag 31 comes to contact the occupant seated in the rear seat 20 when the airbag 31 is inflated and deployed, the perforation line 74 of the stretch tether 70 becomes broken gradually, so that the stretch tether 70 stretches and the fourth sheet 64 folded in the bellows shape stretches in the deployment direction.

The stretch portions 51c, 52c, 53c provided at the linear deployment parts 51b, 52b, 53b of the first, second and third bag portions 51, 52, 53 are configured similarly to the stretch portion 54c provided at the fourth bag portion 54.

The stretch portion 44 provided at the tip portion of the linear deployment part 42 of the airbag 31 comprises the stretch portions 51c, 52c, 53c, 54c of the first, second, third and fourth bag portions 51, 52, 53, 54.

While the stretch tether 70 of the present embodiment is configured such that the perforation line 74 is of a constant shape, the shape of the perforation line 74 may be changed so as to change the stretch state of the stretch portion 54c.

As shown in FIG. 6, the airbag 31 is made by sewing plural synthetic-resin made sheets together, i.e., the first sheet 61 constituting the first bag portion 51, the second sheet 62 constituting the second bag portion 52, the third sheet 63 constituting the third bag portion 53, and the fourth sheet 64 constituting the fourth bag portion 54.

The first, second, third and fourth sheets 61, 62, 63, 64 are sewed adjacently via respective synthetic-resin made partition sheets 65. Each of the partition sheets 65 includes a connection hole 37 through which inside spaces of the adjacent first, second, third and fourth bag portions 51, 52, 53, 54 are interconnected as shown in FIGS. 6 and 7.

The airbag 31 has the gas supply ports 35 at respective vehicle forward sides of the second and third bag portions 52, 53 which are arranged at a central side in the vehicle width direction as shown in FIG. 6. The airbag 31 is configured such that the gas from the inflators 33 is supplied to the second and third bag portions 52, 53 through the gas supply ports 35 and also supplied to the first and fourth bag portions 51, 54 through the connection holes 37 of the partition sheets 65, whereby the first, second, third and fourth bag portions 51, 52, 53, 54 are respectively inflated and deployed.

The first, second, third and fourth bag portions 51, 52, 53, 54 are configured such that the stretch portions 51c, 52c, 53c, 54c respectively stretch in the deployment direction by making the tensions act on the tip portions of the linear deployment parts 51b, 52b, 53b, 54b with the inflation pressure of the airbag 31 until the airbag 31 comes to contact the occupant seated in the rear seat 20 when these bag portions 51, 52, 53, 54 are inflated and deployed.

A tip portion of the airbag 31 includes vent holes 38 through which the gas inside the airbag 31 is exhausted when a load acts on the airbag 31 from the occupant P seated in the rear seat 29 in the vehicle collision. The vent holes 38 are formed at respective outward sides, in the vehicle width direction, of respective vehicle forward sides of the first and fourth bag portion 51, 54 which are arranged on the outward sides, in the vehicle width direction, of the airbag 31. The airbag 31 absorbs impact energy by exhausting the gas inside the airbag 31 to the outside through the vent holes 38.

FIG. 9 is an explanatory diagram explaining the state where the airbag is inflated and deployed. In the present rear-seat airbag device 30, the inflator 33 operates to supply the gas into the airbag 31 in the vehicle collision, the above-described breakage part of the airbag 31 is broken, and the airbag 31 is inflated and deployed toward the vehicle rearward side from the seatback 12, whereby the airbag 31 is inflated and deployed so as to have the curved deployment part 41 and the linear deployment part 42 as shown in FIG. 9.

The curved deployment part 41 and the linear deployment part 42 of the airbag 31 are located at respective positions which correspond to the chest P1 and the knee P2 of the occupant P seated in the rear seat 20, so that the occupant P is protected in the vehicle collision by receiving the chest P1 and the knee P2 of the occupant P who is moved toward the vehicle forward side.

When the airbag 31 is inflated and deployed, in a case where the occupant P is the standard-sized occupant, the stretch portion 44 provided at the tip portion of the linear deployment part 42 stretches more than a case where the occupant P is the large-sized occupant, and in a case where the occupant P is the small-sized occupant, the stretch portion 44 stretches more than a case where the occupant P is the standard-sized occupant, so that the linear deployment part 42 stretches properly and the curved deployment part 41 receives the chest P1 of the occupant P regardless of the body size of the occupant P, thereby protecting the occupant P properly.

The linear deployment part 42 contacts the knee P2 of the occupant P in the pulled state of the connecting tether 36 in a case where the small-sized occupant is seated, the linear deployment part 42 contacts the knee P2 of the occupant P in the slightly loosened state of the connecting tether 36 in a case where the standard-sized occupant is seated, and the linear deployment part 42 contacts the knee P2 of the occupant P in the greatly loosened state of the tether 36 in a case where the large-sized occupant is seated, so that the linear deployment part 42 moves properly in the vertical direction and receives the knee P2 of the occupant P regardless of the body size of the occupant P, thereby protecting the occupant P properly.

The curved deployment part 41 moves in the vertical direction in accordance with the vertical move of the linear deployment part 42 such that in a case where the occupant P is the standard-sized occupant, the curved deployment part 41 moves upwardly more than a case where the occupant P is the small-sized occupant, and in a case where the occupant P is the large-sized occupant, the curved deployment part 41 moves upwardly more than a case where the occupant P is the standard-sized occupant, so that the curved deployment part 41 moves in the vertical direction properly and receives the chest P1 of the occupant P regardless of the body size of the occupant P, thereby protecting the occupant P properly.

While the airbag 31 of the present embodiment is configured to comprise the first, second, third and fourth bag portions 51, 52, 53, 54 when the airbag 31 is inflated and deployed, the number of bag portions is not limited to four but the airbag 31 may comprise two or three bag portions.

As described above, according to the rear-seat airbag device 30 of the present embodiment, the airbag 31 which is provided in the seatback 12 of the front seat 10 and protect the occupant P seated in the rear seat 20 includes the deployment part 40 which is deployed from the seatback 12 toward the vehicle rearward side and then toward the vehicle downward-and-forward side up to the seatback 12.

Thereby, the airbag 31 can securely protect the chest P1 and the knee P2 of the occupant P which are respectively achieved by its part 41 deployed toward the vehicle rearward side and its part 42 deployed toward the vehicle downward-and-forward side from the above-described rearwardly-deployed part 41 of the airbag 31.

Since the deployment part 40 of the airbag 31 includes the stretch portion 44 which is stretchable according to the tension acting on the tip portion of the deployment part 40 when the airbag 31 is inflated and deployed, the airbag 31 can be made close to the chest P1 of the occupant P by stretching the stretch portion 44 in accordance with the body size of the occupant P, so that the occupant P can be securely protected even in a case where the body size of the occupant P differs.

Further, the airbag 31 includes the curved deployment part 41 which is deployed in the curved shape from the seatback 12 toward the vehicle rearward side and the linear deployment part 42 which is deployed in the linear shape from the curved deployment part 41 toward the vehicle downward-and-forward side up to the seatback 12, and the linear deployment part 42 has the stretch portion 44 at the vehicle forward side thereof.

Thereby, the hollow 43 is formed between the curved deployment part 41 and the linear deployment part 42, so that the airbag 31 can be made properly compact. Further, the airbag 31 is deployed promptly in the vehicle collision, so that the protection of the chest P1 and the knee P2 of the occupant P can be effectively achieved by the curved deployment part 41 and the linear deployment part 42. Even in a case where a distance between the front seat 10 and the rear seat 20 changes, the deployment of the airbag 31 is made so fast that the protection of the occupant P can be secured.

Moreover, the linear deployment part 42 is configured to be deployed linearly in the inclined direction from the position located on the vehicle rearward side and on the vehicle upward side of the knee P2 of the occupant P to the position located on the vehicle forward side and on the vehicle downward side of the knee P2 of the occupant P. The occupant protection can be effectively achieved by the airbag 31 including the above-described linear deployment part 42.

While the rear-seat airbag device 30 is installed to the vehicle 1 equipped with the front seat 10 and the rear seat 20 in the present embodiment, there may be provided a first-row seat, a second-row seat, and a third-row seat at a vehicle and the rear-seat airbag device 30 may be arranged at the first-row seat for protecting an occupant seated in the second-row seat, or the rear-seat airbag device 30 may be arranged at the second-row seat for protecting an occupant seated in the third-row seat.

The present invention should not be limited to the above-described embodiment and any other modifications or improvements may be applied within the scope of a spirit of the present invention.

What is claimed is:

1. A rear-seat airbag device which is installed to a vehicle equipped with a front seat and a rear seat, comprising:
an airbag provided in a seatback of the front seat and configured to be inflated and deployed toward a vehicle rearward side for protecting an occupant seated in the rear seat in a vehicle collision,
wherein said airbag includes an deployment part which is deployed from said seatback toward the vehicle rearward side and then toward a vehicle downward-and-forward side up to the seatback of the front seat when the airbag is inflated and deployed, and
said deployment part of the airbag includes a stretch portion which is stretchable according to a tension acting on a tip portion of said deployment part when the airbag is inflated and deployed.

2. The rear-seat airbag device of claim 1, wherein said airbag includes, as said deployment part, a curved deployment part which is deployed in a curved shape from the seatback toward the vehicle rearward side for protecting a chest of the occupant and a linear deployment part which is deployed in a linear shape from said curved deployment part toward the vehicle downward-and-forward side up to the seatback of the front seat for protecting a knee of the occupant, and said linear deployment part has said stretch portion at a vehicle forward side thereof.

3. The rear-seat airbag device of claim 2, wherein said linear deployment part of the airbag is configured to be deployed linearly in an inclined direction from a position located on the vehicle rearward side and on a vehicle upward side of the knee of the occupant to a position located on the vehicle forward side and on a vehicle downward side of the knee of the occupant.
